(19) United States
(12) Patent Application Publication
(10) Pub. No.: US 2023/0360635 A1
(43) Pub. Date: Nov. 9, 2023

(54) SYSTEMS AND METHODS FOR EVALUATING AND SURFACING CONTENT CAPTIONS

(71) Applicant: Meta Platforms, Inc., Menlo Park, CA (US)

(72) Inventor: Gregory Mostitsky, Pleasanton, CA (US)

(21) Appl. No.: 17/239,448

(22) Filed: Apr. 23, 2021

(51) Int. Cl. G10L 15/01; G10L 15/26; G10L 15/08; G10L 15/07; G06N 20/00

(52) U.S. Cl. CPC G10L 15/01; G10L 15/26; G10L 15/083; G10L 15/07; G06N 20/00; G10L 2015/088

(57) ABSTRACT

Systems, methods, and non-transitory computer-readable media can be configured to determine captions generated for a content item. The captions are a transcription of audio associated with the content item. The generated captions can be classified based on one or more techniques. The generated captions are classified to reflect a level of quality associated with the generated captions. An interface can be provided through which the content item and the captions generated for the content item can be accessed.

### FIELD OF THE INVENTION

The present technology relates to the field of digital content processing. More particularly, the present technology relates to evaluating and surfacing content captions.

### BACKGROUND

Today, people often utilize computing devices (or systems) for a wide variety of purposes. For example, users can utilize computing devices to access a social networking system (or service). The users can utilize the computing devices to interact with one another, share content items, and view content items via the social networking system. For example, a user may share a content item, such as an image, a video, an article, or a link, via a social networking system. Other users may access the social networking system and interact with the shared content item. Before posting content items on the social networking system, users may attempt to customize the content items for their intended audience.

### SUMMARY

Various embodiments of the present technology can include systems, methods, and non-transitory computer readable media configured to determine captions generated for a content item. The captions are a transcription of audio associated with the content item. The generated captions can be classified based on one or more techniques. The generated captions are classified to reflect a level of quality associated with the generated captions. An interface can be provided through which the content item and the captions generated for the content item can be accessed.

In an embodiment, the captions are generated based on a speech-to-text algorithm, wherein the speech-to-text algorithm transcribes the audio associated with the content item and provides one or more words and respective word-level confidence scores, and wherein a word-level confidence score indicates a likelihood that a word was accurately transcribed by the speech-to-text algorithm.

In an embodiment, the generated captions are classified based on a heuristic technique that determines an overall confidence score for the generated captions based on phrase-level scores of phrases in the generated captions, and wherein the generated captions are classified based on the overall confidence score.

In an embodiment, a phrase comprises a set of words included in the generated captions, and wherein the phrase is constructed based on at least one of: a rule, audio break, or speaker identity.

In an embodiment, a phrase-level score for the phrase is determined based on word-level confidence scores associated with the set of words from which the phrase was constructed.

In an embodiment, the generated captions are classified based on a level of quality predicted for the generated captions by a machine learning model that analyzes information describing the generated captions.

In an embodiment, the machine learning model is provided a feature vector that includes at least one of the generated captions, a classification of the content item based on subject matter, a duration of the content item, metadata associated with the content item, an audience size expected to access the content item, a geographic distribution associated with the expected audience size, a language associated with the generated captions, or a locale associated with the content item.

In an embodiment, the machine learning model is trained using training examples constructed from information describing captions that were generated for previously published content items and whether those content items were published with or without their respective captions.

In an embodiment, the interface provides a region to review the content item with the generated captions.

In an embodiment, the interface provides a region to edit snippets of the generated captions.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including a content provider, according to an embodiment of the present technology.

FIG. 2 illustrates an example approach for evaluating content captions, according to an embodiment of the present technology.

FIG. 3 illustrates another example approach for evaluating content captions, according to an embodiment of the present technology.

FIGS. 4A-4B illustrate example interfaces, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Today, people often utilize computing devices (or systems) for a wide variety of purposes. For example, users can utilize computing devices to access a social networking system (or service). The users can utilize the computing devices to interact with one another, share content items, and view content items via the social networking system. For example, a user may share a content item, such as an image, a video, an article, or a link, via a social networking system. Another user may access the social networking system and interact with the shared content item.

Content items (e.g., videos) often include both visual content and audio content. Content items can be captioned (or subtitled), for example, to improve user accessibility of associated audio content. For instance, captions generated for a content item can be presented as text while the content item is played. Captions may be “open” or “closed”. Open captions can be shown by default when a content item is played. In contrast, closed captions can be shown only after a user (or viewer) selects an option to view the captions. Under conventional approaches, captions can be generated manually or automatically. Under a manual approach, captions can be produced manually by humans that review and transcribe audio content. Captions that are produced manually are typically high in quality but can be expensive and time consuming to produce. In many instances, the cost and time needed to manually produce captions can make this approach impractical for most content publishers. An automated computerized approach for generating captions can help reduce cost and time needed to produce captions. However, computer generated captions may not be as accurate as manually produced captions. Further, content publishers typically have no way to easily ascertain whether computer generated captions for their content are reliable and, if so, to what extent they are reliable. As a result, content publishers may be discouraged from captioning their content, which can hurt viewer engagement from a wide array of viewers, such as viewers that are hearing impaired or viewers that prefer to access content without sound. Thus, conventional approaches pose these and other problems arising in computer technology.

An improved approach rooted in computer technology overcomes the foregoing and other disadvantages associated with conventional approaches specifically arising in the realm of computer technology. In various embodiments, the present technology provides for caption generation and evaluation. For example, a content publisher can provide a content item for distribution through a content provider, such as a social networking system. The present technology can automatically generate captions for the content item. The present technology can evaluate the automatically generated captions for accuracy based on various approaches. For example, the present technology can apply heuristics and machine learning to score the generated captions based on transcription accuracy. In some embodiments, the present technology can classify the generated captions as high quality or low quality based on transcription accuracy. The generated captions and classification can be surfaced through an interface. In instances where the generated captions are classified as high quality, the content provider can distribute the content item with the generated captions without further review. Otherwise, the content publisher can select an option to review and correct the generated captions through the interface. As a result, the present technology can provide insights and tools that help encourage content publishers to more accurately caption their digital content. More details relating to the present technology are provided below.

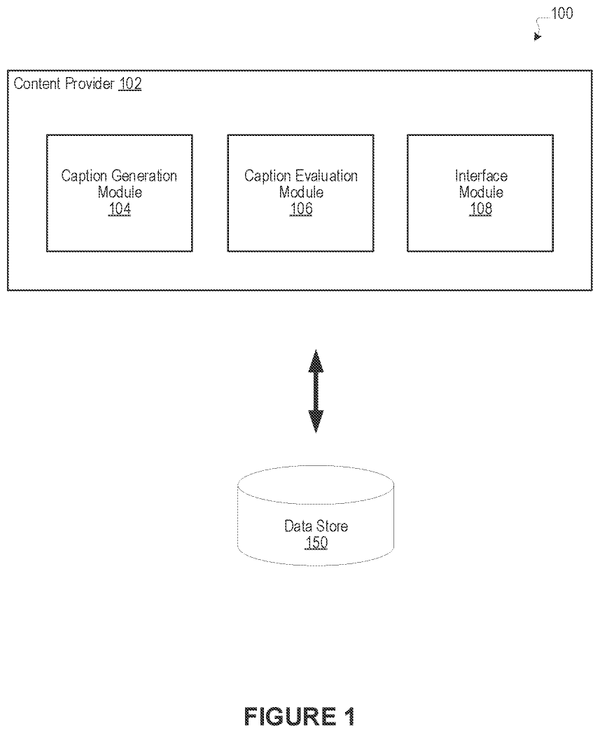

FIG. 1 illustrates an example system 100 including a content provider 102, according to an embodiment of the present technology. As shown in the example of FIG. 1, the content provider 102, such as a social networking system, can include a caption generation module 104, a caption evaluation module 106, and an interface module 108. In some instances, the example system 100 can include a data store 150 in communication with the content provider 102. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the caption generation module 104, the caption evaluation module 106, and the interface module 108 can be implemented in any suitable combinations.

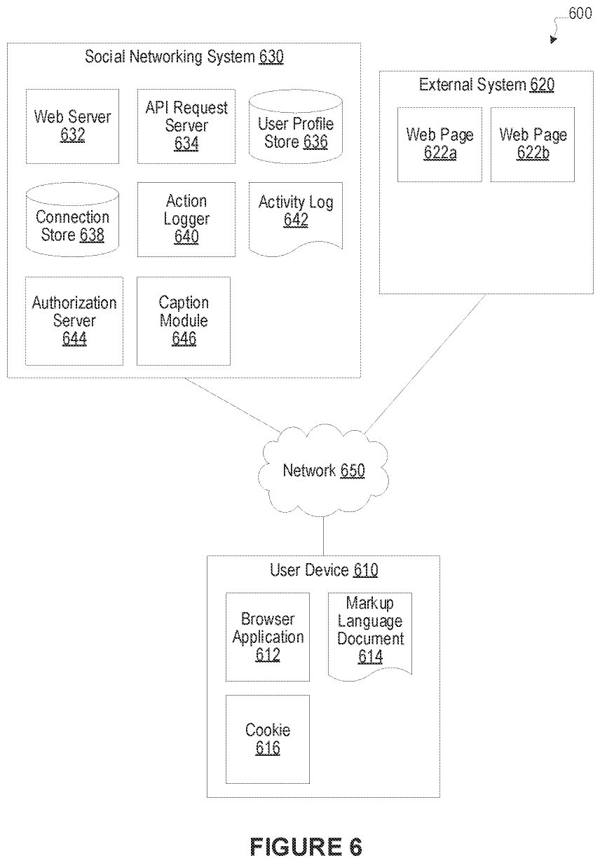

In some embodiments, the caption generation module 104, the caption evaluation module 106, and the interface module 108 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the caption generation module 104, the caption evaluation module 106, and the interface module 108 can be, in part or in whole, implemented as software running on one or more computing devices or systems, such as on a server system or a client computing device. In some instances, the caption generation module 104, the caption evaluation module 106, and the interface module 108 can be, in part or in whole, implemented within or configured to operate in conjunction with or be integrated with a social networking system (or service), such as a social networking system 630 of FIG. 6. Likewise, in some instances, the caption generation module 104, the caption evaluation module 106, and the interface module 108 can be, in part or in whole, implemented within or configured to operate in conjunction with or be integrated with a client computing device, such as the user device 610 of FIG. 6. For example, the caption generation module 104, the caption evaluation module 106, and the interface module 108 can be implemented as or within a dedicated application (e.g., app), a program, or an applet running on a user computing device or client computing system. The application incorporating or implementing instructions for performing functionality of the caption generation module 104, the caption evaluation module 106, and the interface module 108 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The caption generation module 104, the caption evaluation module 106, and the interface module 108 can be configured to communicate and/or operate with the data store 150, as shown in the example system 100. The data store 150 can be configured to store and maintain various types of data. In some implementations, the data store 150 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 150 can store information that is utilized by the caption generation module 104, the caption evaluation module 106, and the interface module 108. For example, the data store 150 can store information associated with a video and different versions of the video that have been optimized for display on various surfaces. It is contemplated that there can be many variations or other possibilities.

The caption generation module 104 can be configured to generate captions for content items. For example, the caption generation module 104 can access a content item provided (or uploaded) by a content publisher for publication via a content provider (e.g., a social networking system). The caption generation module 104 can analyze audio content associated with the content item to generate captions for the content item. The caption generation module 104 can apply generally known techniques for automatically transcribing audio content including, for example, conventional speech-to-text techniques. The generated captions can represent the audio content as text, which can be displayed as open or closed captions while the content item is accessed (or played).

The caption evaluation module 106 can be configured to evaluate captions generated by the caption generation module 104 based on various techniques. For example, the caption evaluation module 106 can analyze captions that were generated for a content item to determine their accuracy. Based on this analysis, the caption evaluation module 106 can classify the captions into a particular quality level. For example, captions determined to satisfy a threshold level of accuracy can be classified as high quality. In contrast, captions determined not to satisfy the threshold level of accuracy can be classified as low quality. Many variations are possible. For instance, multiple thresholds can be utilized to classify captions with more granularity. For example, captions may be classified as low quality, medium quality, or high quality.

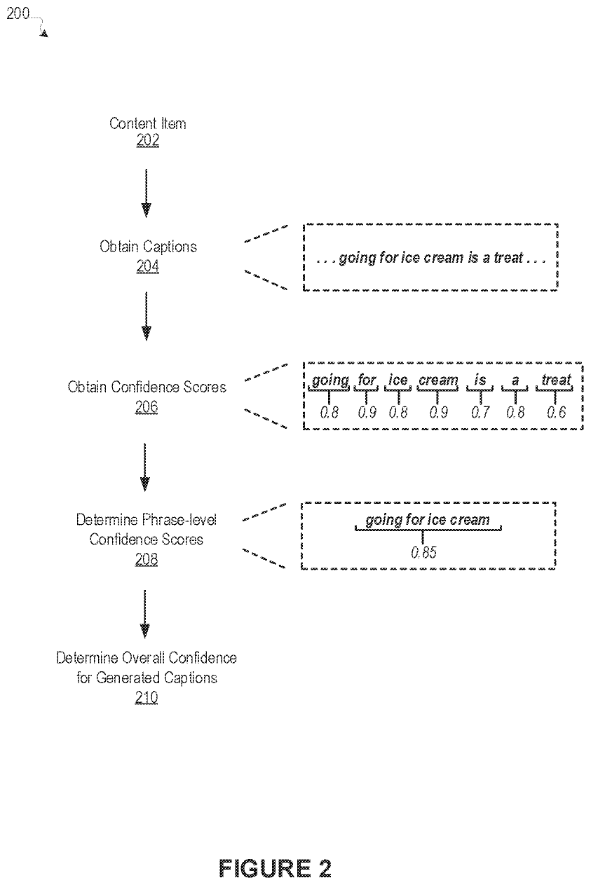

In some embodiments, the caption evaluation module 106 can be configured to evaluate captions for accuracy based on a heuristic technique 200, as illustrated in the example of FIG. 2. For example, at block 202, the caption evaluation module 106 can access a content item. The content item may be provided (or uploaded) by a content publisher to a content provider (e.g., a social networking system). The content item can be any type of media item that includes audio content. As used herein, audio content refers to audio content that includes any amount or any type of speech (e.g., speaking, singing, rapping, verbal expression, etc.). For example, the content item can be a video that includes both visual content and audio content. In another example, the content item can be a podcast that includes only audio content. Many variations are possible.

At block 204, the caption evaluation module 106 can obtain captions generated for the content item. For example, the captions can be generated by the caption generation module 104 using conventional approaches for automatically analyzing and transcribing speech represented in audio content. For example, a conventional speech-to-text algorithm can be applied to analyze speech represented in audio content associated with the content item and output corresponding captions as text.

At block 206, the caption evaluation module 106 can obtain confidence scores for the generated captions. In general, the speech-to-text algorithm used to generate the captions can also provide confidence scores for the generated captions at varying levels of granularity. For example, the speech-to-text algorithm can provide a word-level confidence score for each captioned word in the generated captions. A confidence score can be, for example, a number between 0 (low confidence) and 1 (high confidence) which indicates a likelihood that a word was accurately transcribed by the speech-to-text algorithm. As an example, a portion of the generated captions may include the text “going for ice cream is a treat”. In this example, each word can be associated with its word-level confidence score as determined by the speech-to-text algorithm. Thus, the word “going” may be associated with a word-level confidence score of 0.8, the word “for” may be associated with a confidence score of 0.9, the word “ice” may be associated with a word-level confidence score of 0.8, the word “cream” may be associated with a word-level confidence score of 0.9, the word “is” may be associated with a word-level confidence score of 0.7, the word “a” may be associated with a word-level confidence score of 0.8, and the word “treat” may be associated with a word-level confidence score of 0.6. Other confidence scores can be used instead of or in combination with word-level scores. For example, token-level confidence scores and phrase-level confidence scores, as generated by a speech-to-text algorithm, may also be used. Many variations are possible.

At block 208, the caption evaluation module 106 can determine (or calculate) phrase-level confidence scores for the generated captions. For example, the caption evaluation module 106 can combine words in the generated captions into phrases. The caption evaluation module 106 can apply one or more approaches to combine words into phrases. For example, the caption evaluation module 106 can combine words into phrases based on pre-defined rules. In this example, pre-defined rules can be applied to captions to identify combinations of words that correspond to some type of phrase (e.g., noun phrase, verb phrase, gerund phrase, etc.). In another example, the caption evaluation module 106 can combine words into phrases based on breaks in audio. For example, the caption evaluation module 106 can identify gaps in speech (or periods of silence). The gaps may be determined based on an analysis of audio associated with a content item, an analysis of captions generated for the content item, or both. Based on the gaps in speech, the caption evaluation module 106 can segment generated captions into phrases. In yet another example, the caption evaluation module 106 can combine words into phrases based on speaker identity. For example, the caption evaluation module 106 can apply generally known speaker diarization techniques to segment the captions by speaker identity. The caption evaluation module 106 can then combine words that were spoken by a given speaker into phrases. When combining words associated with a given speaker, the caption evaluation module 106 can also apply other approaches to combine words into phrases, as described above. Once a group of words has been combined to form a phrase, the caption evaluation module 106 can determine a phrase-level confidence score for the formed phrase. In some embodiments, the caption evaluation module 106 can determine the phrase-level confidence score as a weighted average of confidence scores associated with the words that form the phrase. For example, the caption evaluation module 106 can determine the phrase “going for ice cream” has a phrase-level score of 0.85. Many variations are possible.

At block 210, the caption evaluation module 106 can determine an overall confidence score for the generated captions. The overall confidence score can be determined based on phrase-level confidence scores that were determined based on the generated captions. For example, the caption evaluation module 106 can categorize phrases associated with a phrase-level confidence score that satisfies a threshold value T1 into a group of passable phrases. The caption evaluation module 106 can determine the overall confidence score for the generated captions based on a ratio of a numerator that corresponds to a count of the passable phrases in the generated captions and a denominator that corresponds to a total count of a phrases in the generated captions. In some embodiments, if the overall confidence score satisfies a threshold value T2, the caption evaluation module 106 can classify the generated captions as high quality captions. Otherwise, the caption evaluation module 106 can classify the generated captions as low quality captions. Many variations are possible. For example, in some instances, because viewers may not always watch a content item in its entirety, a content publisher may desire greater accuracy from captions that correspond to the beginning of the content item (e.g., the first 10 minutes) than from captions that correspond to the end of the content item (e.g., the last 5 minutes). Thus, in some embodiments, when calculating an overall confidence score for generated captions of the content item, phrases that correspond to the beginning of the content item can be weighted more than phrases that correspond to the end of the content item. In some embodiments, a different approach can be applied to evaluate captions with fewer than a threshold count of total phrases. In such embodiments, in order for the captions to be classified as high quality captions, all phrase-level confidence scores for phrases associated with the captions must satisfy the threshold value T1. Again, many variations are possible.

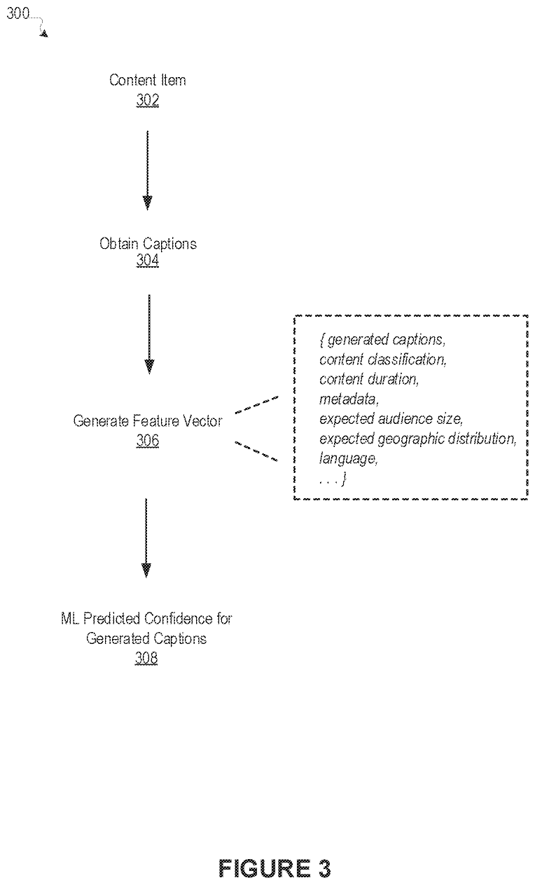

In some embodiments, the caption evaluation module 106 can be configured to evaluate captions for accuracy based on a machine learning technique 300, as illustrated in the example of FIG. 3. For example, at block 302, the caption evaluation module 106 can access a content item. The content item may be provided (or uploaded) by a content publisher to a content provider (e.g., a social networking system). The content item can be any type of media that includes audio content.

At block 304, the caption evaluation module 106 can obtain captions generated for the content item. For example, the captions can be generated by the caption generation module 104 using conventional approaches for automatically analyzing and transcribing speech represented in audio content. For example, a conventional speech-to-text algorithm can be applied to analyze audio content associated with the content item and output corresponding captions as text.

At block 306, the caption evaluation module 106 can generate a feature vector that represents various features associated with the content item. For example, in some embodiments, the feature vector can include a feature that represents the captions generated for the content item. In some embodiments, the feature vector can include a feature that represents a classification of audiovisual subject matter represented in the content item. For example, the classification can indicate the content item relates to a content category, such as sports, politics, or cooking. In some embodiments, the feature vector can include a feature that represents a duration (or length) of the content item. In some embodiments, the feature vector can include a feature that represents metadata associated with the content item (e.g., description, title, keywords, file dimensions, file types, etc.). In some embodiments, the feature vector can include a feature that represents a predicted audience size for the content item. For example, the feature can indicate a total number of viewers that are expected to access the content item through a content provider (e.g., a social networking system), for example, based on historical viewing patterns and interests. In some embodiments, the feature vector can include a feature that represents a geographic distribution of the predicted audience. For example, the feature can indicate geographic regions from which viewers are expected to access the content item. The geographic regions can be represented at varying levels of granularity, such as continents, countries, states, cities, and zip codes, to name some examples. In some embodiments, the feature vector can include a feature that represents a language associated with the content item. In some embodiments, the feature vector can include a feature that represents a locale associated with the content item. Many different features are possible.

At block 308, the caption evaluation module 106 can provide the feature vector to a machine learning model for evaluation. The machine learning model can be trained to evaluate features in the feature vector and predict an overall confidence score for the generated captions. In some embodiments, the machine learning model is trained based on a binary classification algorithm. For example, based on evaluation of the feature vector, the machine learning model can output a “high quality” or “low quality” classification. The machine learning technique 300 provides an improvement over the heuristic technique 200 because the machine learning technique 300 can evaluate features that are not considered under the heuristic technique 200. For instance, the machine learning technique 300 can determine that content items relating to politics can require captions to be more accurate than content items relating to cooking. As a result, the machine learning technique 300 can customize caption accuracy predictions by taking into account that different content can have different expectations and requirements for captions accuracy. Many variations are possible.

In various embodiments, the caption evaluation module 106 can train the machine learning model based on training examples generated from historical publication data. For example, a training example can be constructed based on information describing captions that were previously generated for a content item and whether the content item was published with or without the generated captions. If the content item is published with the generated captions, then it is more likely the generated captions satisfied a threshold level of accuracy. Otherwise, if the content item is published without the generated captions, then it is less likely the generated captions satisfied the threshold level of accuracy. As an example, a training example can include features, such as captions generated for a content item, a classification of the content item based on subject matter, a duration of the content item, metadata associated with the content item, an expected audience size for the content item, an expected geographic distribution of the content item, a language associated with the content item, and a locale associated with the content item, to name some examples. An indication of whether the content item was published with or without the generated captions can be associated with the training example as a supervisory signal. Many variations are possible.

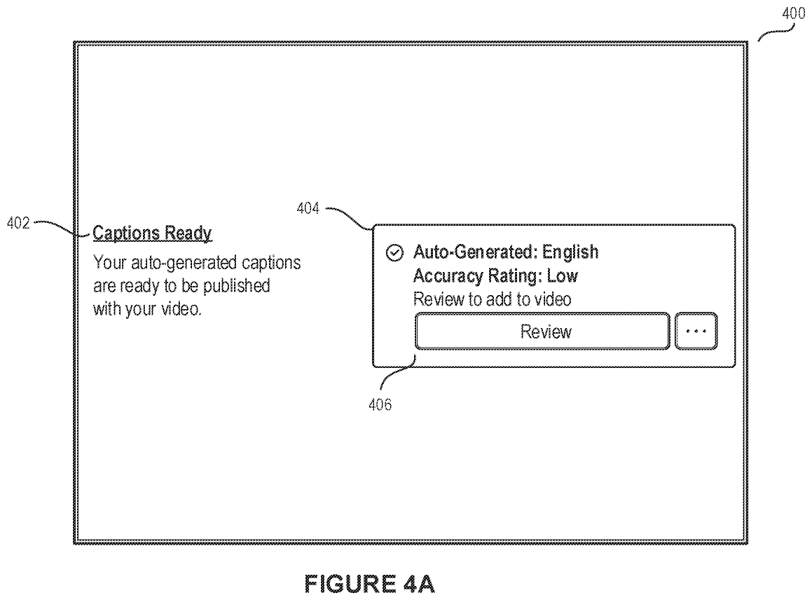

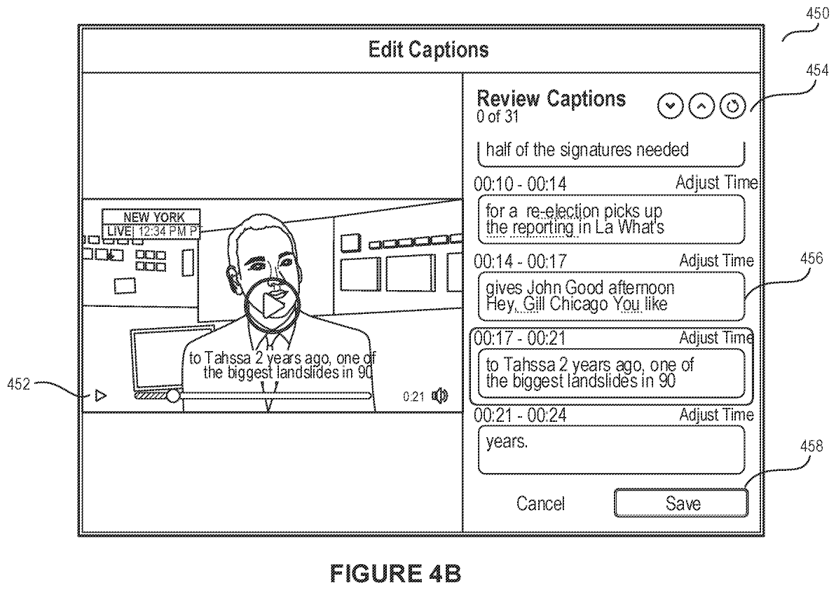

The interface module 108 can be configured to provide interfaces for generating and managing captions. For example, a content publisher can upload a content item to be published through a content provider (e.g., a social networking system). Captions can be generated for the uploaded content item, as described herein. The generated captions can be evaluated, as described herein. In this example, the interface module 108 can provide an interface 400 as illustrated in the example of FIG. 4A. The interface 400 can provide a message 402 relating to the generated captions. The interface 400 can also provide information 404 describing the generated captions, such as a language associated with the generated captions and an accuracy rating associated with the generated captions (e.g., high quality, low quality, accuracy score, etc.). In this example, the content publisher can select an option 406 to review the generated captions in more detail, as illustrated in the example interface 450 of FIG. 4B. The example interface 450 includes a first region 452 that allows review (or playback) of the uploaded content item with the generated captions. For example, the first region 452 can provide video playback controls that allows the content publisher to scrub through the uploaded content item. The interface 450 also includes a second region 454 that provides snippets of captions that each are a transcription of speech represented in some portion of audio associated with the uploaded content item. For example, a snippet of captions can be provided in an editable field 456. In some implementations, snippets of captions determined to be of relatively low quality can be displayed with more prominence or more priority than snippets of captions determined to be of relatively high quality in order to invite content publisher scrutiny where most warranted. A time period (e.g., 00:14-00:17) associated with the snippet of captions can be provided to indicate when the snippet of captions will be presented during playback of the content item. The content publisher can interact with the editable field 456 to edit (or correct) the snippet of captions and/or adjust the associated time period during which the snippet of captions will be shown. The content publisher can select options provided in the second region 454 to navigate (or scroll) to additional snippets of captions generated for different portions of the content item. The content publisher can select a save option 458 to save edits to the snippets of captions. The content item can then be published with the saved snippets of captions. Many variations are possible.

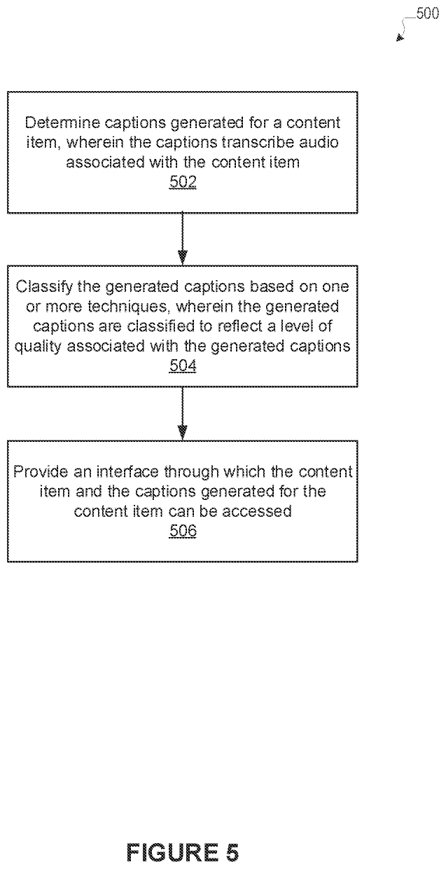

FIG. 5 illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 can determine captions generated for a content item, wherein the captions are a transcription of audio associated with the content item. At block 504, the example method 500 can classify the generated captions based on one or more techniques, wherein the generated captions are classified to reflect a level of quality associated with the generated captions. At block 506, the example method 500 can provide an interface through which the content item and the captions generated for the content item can be accessed.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a caption module 646. The caption module 646 can be implemented with, for example, the caption generation module 104, the caption evaluation module 106, and the interface module 108, as discussed in more detail herein. In some embodiments, some functionality of the caption module 646 can be performed by the user device 610. It should be appreciated that there can be many variations or other possibilities.

### Hardware Implementation

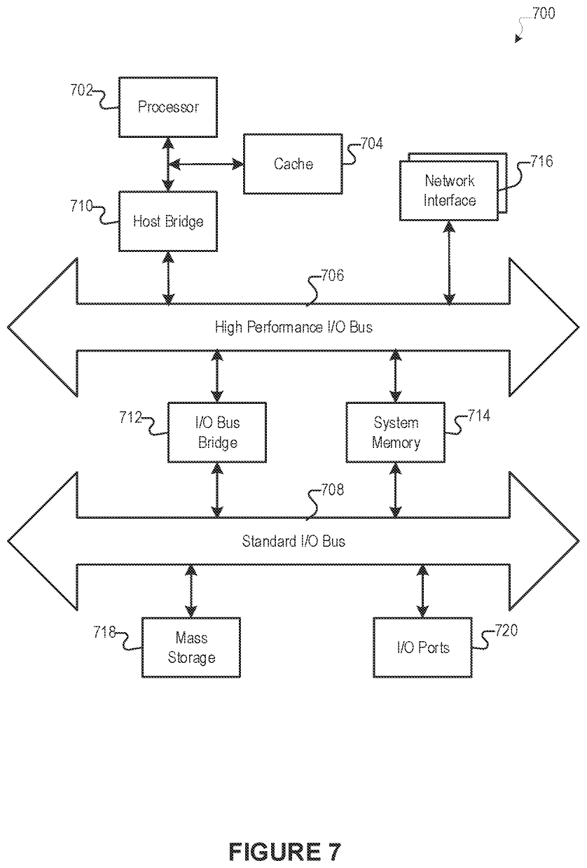

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, California, and the x86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, captions generated for a content item, wherein the captions are a transcription of audio associated with the content item;
classifying, by the computing system, the generated captions based on one or more techniques, wherein the generated captions are classified by a machine learning model to reflect a level of quality associated with the generated captions, the machine learning model trained based on training data including captions generated for content items and a supervisory signal associated with whether the content items were published with captions; and
providing, by the computing system, an interface through which the content item and the captions generated for the content item can be accessed.

2. The computer-implemented method of claim 1, wherein the captions are generated based on a speech-to-text algorithm, wherein the speech-to-text algorithm transcribes the audio associated with the content item and provides one or more words and respective word-level confidence scores, and wherein a word-level confidence score indicates a likelihood that a word was accurately transcribed by the speech-to-text algorithm.

3. The computer-implemented method of claim 1, wherein the generated captions are classified based on a heuristic technique that determines an overall confidence score for the generated captions based on phrase-level scores of phrases in the generated captions, and wherein the generated captions are classified based on the overall confidence score.

4. The computer-implemented method of claim 3, wherein a phrase comprises a set of words included in the generated captions, and wherein the phrase is constructed based on at least one of: a rule, audio break, or speaker identity.

5. The computer-implemented method of claim 4, wherein a phrase-level score for the phrase is determined based on word-level confidence scores associated with the set of words from which the phrase was constructed.

6. The computer-implemented method of claim 1, wherein the generated captions are classified based on a level of quality predicted for the generated captions by the machine learning model that analyzes information describing the generated captions.

7. The computer-implemented method of claim 6, wherein the machine learning model is provided a feature vector that includes at least one of the generated captions, a classification of the content item based on subject matter, a duration of the content item, metadata associated with the content item, an audience size expected to access the content item, a geographic distribution associated with the expected audience size, a language associated with the generated captions, or a locale associated with the content item.

8. The computer-implemented method of claim 6, wherein the machine learning model is trained using training examples constructed from information describing captions that were generated for previously published content items and whether those content items were published with or without their respective captions.

9. The computer-implemented method of claim 1, wherein the interface provides a region to review the content item with the generated captions

10. The computer-implemented method of claim 1, wherein the interface provides a region to edit snippets of the generated captions.

11. A system comprising:
at least one processor; and
a memory storing instructions that, when executed by the at least one processor, cause the system to perform:
determining captions generated for a content item, wherein the captions are a transcription of audio associated with the content item;
classifying the generated captions based on one or more techniques, wherein the generated captions are classified by a machine learning model to reflect a level of quality associated with the generated captions, the machine learning model trained based on training data including captions generated for content items and a supervisory signal associated with whether the content items were published with captions; and
providing an interface through which the content item and the captions generated for the content item can be accessed.

12. The system of claim 11, wherein the captions are generated based on a speech-to-text algorithm, wherein the speech-to-text algorithm transcribes the audio associated with the content item and provides one or more words and respective word-level confidence scores, and wherein a word-level confidence score indicates a likelihood that a word was accurately transcribed by the speech-to-text algorithm.

13. The system of claim 11, wherein the generated captions are classified based on a heuristic technique that determines an overall confidence score for the generated captions based on phrase-level scores of phrases in the generated captions, and wherein the generated captions are classified based on the overall confidence score.

14. The system of claim 13, wherein a phrase comprises a set of words included in the generated captions, and wherein the phrase is constructed based on at least one of: a rule, audio break, or speaker identity.

15. The system of claim 14, wherein a phrase-level score for the phrase is determined based on word-level confidence scores associated with the set of words from which the phrase was constructed.

16. A non-transitory computer-readable storage medium including instructions that, when executed by at least one processor of a computing system, cause the computing system to perform:
determining captions generated for a content item, wherein the captions are a transcription of audio associated with the content item;
classifying the generated captions based on one or more techniques, wherein the generated captions are classified by a machine learning model to reflect a level of quality associated with the generated captions, the machine learning model trained based on training data including captions generated for content items and a supervisory signal associated with whether the content items were published with captions; and
providing an interface through which the content item and the captions generated for the content item can be accessed.

17. The non-transitory computer-readable storage medium of claim 16, wherein the captions are generated based on a speech-to-text algorithm, wherein the speech-to-text algorithm transcribes the audio associated with the content item and provides one or more words and respective word-level confidence scores, and wherein a word-level confidence score indicates a likelihood that a word was accurately transcribed by the speech-to-text algorithm.

18. The non-transitory computer-readable storage medium of claim 16, wherein the generated captions are classified based on a heuristic technique that determines an overall confidence score for the generated captions based on phrase-level scores of phrases in the generated captions, and wherein the generated captions are classified based on the overall confidence score.

19. The non-transitory computer-readable storage medium of claim 18, wherein a phrase comprises a set of words included in the generated captions, and wherein the phrase is constructed based on at least one of: a rule, audio break, or speaker identity.

20. (canceled)

20. The computer-implemented method of claim 1, wherein the training data further includes subject matter classifications of the content items based on audiovisual information associated with the content items.
